(19) United States
(12) Patent Application Publication
(10) Pub. No.: US 2019/0084844 A1
(43) Pub. Date: Mar. 21, 2019

(54) TREATMENT OF URINE

(71) Applicant: CRANFIELD UNIVERSITY, Bedfordshire (GB)

(72) Inventor: Ewan James MCADAM, Bedfordshire (GB)

(21) Appl. No.: 16/081,114

(22) PCT Filed: Mar. 1, 2017
(86) PCT No.: PCT/EP2017/054816

§ 371 Date: Aug. 30, 2018

(30) Foreign Application Priority Data
Mar. 1, 2016 (GB) 1603546.1

(51) Int. Cl. C02F 1/44; B01D 61/36; B01D 63/02; B01D 69/08; E03D 11/13

(52) U.S. Cl. CPC C02F 1/447; B01D 61/364; B01D 61/366; B01D 63/02; B01D 69/081; C02F 2103/005; B01D 2311/103; B01D 2311/13; B01D 2313/36; B01D 2313/38; C02F 2209/02; E03D 11/13

(57) ABSTRACT

There is disclosed a process and apparatus for treating urine. Urine is contained in a reservoir and contacted with a liquid side of a separation membrane which also has a gas side. A sweep gas flow is generated on the gas side of the separation membrane. Water in the urine is conducted from the liquid side to the gas flow side of the separation membrane, the separation membrane substantially preventing the passage of other components of urine from the liquid side to the gas flow side of the separation membrane. The water conducted to the gas flow side of the separation membrane is entrained in the sweep gas flow.

### BACKGROUND TO THE INVENTION

### Field of the Invention

The present invention relates to the treatment of urine in the context of domestic sanitation. The invention is particularly, but not exclusively, suitable for use at locations with little or no available power and/or sewage infrastructure, such as in some developing countries and/or in remote locations.

### Related Art

Existing dry toilets, such as pit latrines and composting toilets, are often used in developing countries. They can be dug or manufactured without the need for specialist equipment, but produce unpleasant miasma. They are also unhygienic and unsanitary to use.

Existing chemical toilets provide some improvements over dry toilets, but still produce unpleasant odours and still suffer from hygiene and sanitation problems. Chemical toilets typically are emptied by hand, and the chemicals used can be harmful to the person emptying the toilet. Furthermore, chemical toilets can be expensive to install, and the chemicals used can be expensive to dispose of and replenish. The chemicals used can also be harmful to the environment if not disposed of correctly.

To spread the costs associated with installing and maintaining toilets in developing countries, toilets are often shared by many people. This sharing contributes to hygiene and sanitation problems. Furthermore, because of the unpleasant odour associated with such toilets, they tend to be in remote locations, rather than being in or close to homes.

As such, people may have to walk a long way to access their nearest toilet, further decreasing the incentive to use a communal toilet.

It would therefore be desirable to provide a toilet that is inexpensive to purchase, install and maintain. In this way, it is preferred to develop a toilet that can be installed in a home, intended for the use of the occupiers of that home, which has no need of coupling to a sewer or a running water supply, and which does not has substantial power input requirements. Such a toilet requires means for treatment of faeces, urine, and in many circumstances also faecally-contaminated urine, within the constraints mentioned above.

### SUMMARY OF THE INVENTION

The present disclosure addresses in particular the treatment of urine and optionally also faecally-contaminated urine. The present invention has been devised in order to address at least one of the above problems. Preferably, the present invention reduces, ameliorates, avoids or overcomes at least one of the above problems.

The present invention is based on the inventors' realisation that it may be possible to separate water from urine using a membrane separation approach which requires little or no additional energy input beyond energy that may be readily available from operation of a toilet system with which it is intended that the invention is to be used.

Treatment of contaminated water is a well-established technical field. However, typically attention has been concentrated on large-scale systems such as desalination plants and the like.

Membrane-based water separation processes are known. One example is membrane distillation, and a comprehensive review of membrane distillation is set out in Alkhudhiri et al 2012 [Abdullah Alkhudhiri, Naif Darwish, Nidal Hilal, “Membrane distillation: A comprehensive review” Desalination, Volume 287, Pages 2-18 (2012)]. One type of membrane distillation is sweeping gas membrane distillation. A sweep gas is conducted along a gas side of the membrane, opposite to a liquid side of the membrane. Water vapour molecules are able to pass through the membrane. The driving force for the separation is the water vapour pressure difference between the liquid side and the gas side of the membrane. Another type of membrane distillation is vacuum membrane distillation, having a similar operating principle. In the context of desalination in particular, it is critical to reduce the capital cost of the membrane. For a given membrane material and configuration, therefore, it is usually necessary to boost the efficiency of the membrane distillation process by imposing a thermal gradient across the membrane (heating the liquid and/or cooling the sweep gas). Additionally, it is typically necessary to cool the permeate in order to recover water vapour into the liquid state. Furthermore, it is necessary to pump the contaminated water in order to ensure that a sufficient velocity is maintained in order to maximise mass transfer through the membrane. Still further, it is necessary to pump the sweep gas, or to generate a vacuum for sweeping gas membrane distillation or vacuum membrane distillation, respectively.

Zhao et al 2013 [Zhi-Ping Zhao, Liang Xu, Xin Shang, Kangcheng Chen, “Water regeneration from human urine by vacuum membrane distillation and analysis of membrane fouling characteristics” Separation and Purification Technology, Volume 118, Pages 369-376 (2013)] discloses a study into the efficiency of vacuum membrane distillation for the recovery of water from human urine. The intention of the study was to consider water regeneration from human urine in space, e.g. in a space station. A plate-form microporous hydrophobic membrane of PTFE was used. The average pore size was 0.2 μm and the membrane thickness was 50 μm. Sample urine was delivered to the membrane using a pump with an adjustable flow rate. The sample urine was heated to a range of temperatures: 50° C., 60° C. and 70° C. With the vacuum pulled, the vapour pressure difference across the membrane was about 4 kPa, substantially independent of the sample urine temperature.

Chiari 2000 [A. Chiari, “Air humidification with membrane contactors: experimental and theoretical results” International Journal of Ambient Energy, Volume 21, Issue 4, pp. 187-195 (2000)] discloses an approach to air humidification using a cross-flow membrane contactor. This has similarities with a sweeping gas membrane distillation process, except that there is no intention to purify the water from contaminants on the liquid side of the membrane.

Khayet et al 2000 [Mohamed Khayet, Paz Godino, Juan I. Mengual, “Nature of flow on sweeping gas membrane distillation” Journal of Membrane Science, Volume 170, Issue 2, Pages 243-255 (2000)] discloses a study of sweeping gas membrane distillation. In the study, the liquid feed and the sweep gas are counterflowing in a plate and frame membrane module. The liquid feed was pure water (deionised and distilled).

Membrane distillation has some similarities with pervaporation, also a separation process. However, typically a membrane distillation process uses a porous membrane whereas a pervaporation process uses non-porous membrane. In pervaporation, water transfer across the membrane relies on diffusion of the water molecules through the membrane material.

Based on the work of the present inventors, it has been realised that a membrane-based separation process can be used for the treatment of urine, without the need for energy-intensive measures to be taken. This makes the process particularly suitable to application in a domestic environment, for use in or with a toilet which has no need of coupling to a sewer or a running water supply, and which does not have substantial power input requirements.

Accordingly, in a first preferred aspect, the present invention provides a urine-treatment apparatus having:
a reservoir for containing urine to be treated;
a separation membrane having a liquid side and a gas side, the separation membrane being capable of conducting water in the urine to the gas flow side and capable of substantially preventing the passage of other components of urine to the gas flow side; and
air flow means for generating a sweep gas flow on the gas side of the separation membrane,

wherein the apparatus is operable to extract water from the urine into the sweep gas flow.

In a second preferred aspect, the present invention provides a process for treating urine, the process including the steps:
containing urine in a reservoir;
providing a separation membrane having a liquid side and a gas side;
contacting the urine in the reservoir with the liquid side of the separation membrane;
generating a sweep gas flow on the gas side of the separation membrane;
conducting water in the urine from the liquid side to the gas flow side of the separation membrane, the separation membrane substantially preventing the passage of other components of urine from the liquid side to the gas flow side of the separation membrane, the water conducted to the gas flow side of the separation membrane being entrained in the sweep gas flow.

In a third preferred aspect, the present invention provides a toilet system, the toilet system being adapted to receive human waste including urine and optionally faeces, the toilet system having a urine-treatment apparatus according to the first aspect and a waste collection region from which urine is conducted to the reservoir of the urine-treatment apparatus.

The first, second and/or third aspect of the invention may have any one or, to the extent that they are compatible, any combination of the following optional features.

Preferably, the separation membrane operates to provide membrane distillation or pervaporation.

The membrane may be in the form of elongate conduit, for example hollow fibre. In this case, the interior of the hollow fibre (the lumen) provides the gas side of the membrane and the exterior of the hollow fibre provides the liquid side of the membrane.

Preferably, the membrane has a wall thickness of at least 10 μm. A suitable lower limit of wall thickness ensures that the membrane will not have defects suitable to allow the liquid to enter the gas side with its contaminants. The membrane may have a wall thickness of at least 20 μm or at least 50 μm. The wall thickness may be up to about 500 μm. A suitable upper limit of wall thickness is determined by the required permeate flow rate through the membrane per unit area of the membrane. The wall thickness is intended to include any support layer and/or any thin film layer provided with the membrane.

In the case of a hollow fibre membrane, preferably the inner diameter of the hollow fibre (or, in the case of a non-circular inner lumen cross section, the diameter of a circle of equivalent area as the non-circular inner lumen cross section) is at least 100 μm. The lower limit of the inner diameter is set by the acceptable pressure drop on the gas flow side. The greater the pressure drop, the greater the power input required in order to force the sweep gas flow on the gas side of the membrane. Preferably in use the pressure drop on the gas flow side is not greater than 50 mbar, more preferably not greater than 20 mbar. Typically, the pressure drop on the gas side is 10 mbar or less, for example in the range 5-10 mbar. Such low pressure drops can be serviced using low power components such as a fan, e.g. squirrel fan.

Preferably the inner diameter of the hollow fibre is at most 5000 μm. The upper limit of the inner diameter is determined by the require efficiency of the system. The greater the inner diameter, the less surface area of membrane is available for transport of the water vapour into the sweep gas.

Preferably, the sweep gas in the gas side of the membrane is at a pressure not less than, or not substantially less than, atmospheric pressure. In particular, it is preferred that the gas side does not have a vacuum pulled. The use of close to ambient conditions ensures that the input power requirements of the system are minimised. Atmospheric pressure at sea level is about 1.01×10⁵ kPa. Preferably, the sweep gas in the gas side of the membrane is at a pressure of not less than 99% of ambient pressure.

Preferably, the sweep gas in the gas side of the membrane is at a pressure not substantially greater than atmospheric pressure. Again, the use of close to ambient conditions ensures that the input power requirements of the system are minimised. Preferably, the sweep gas in the gas side of the membrane is at a pressure of not greater than 105% of ambient pressure.

Preferably, the liquid to be treated is heated, e.g. to a temperature greater than the ambient temperature. Conveniently, the toilet system may include means for combusting faeces, such as a gasifier and optionally a subsequent burner. Heat from combusting faeces may be used to heat the liquid to be treated. Preferably, the liquid to be treated is heated to at least 30° C. More preferably, the liquid to be treated is heated to at least 40° C., or at least 50° C. The liquid is preferably not heated to a temperature of greater than 90° C., more preferably not greater than 80° C. Heating the liquid to be treated promotes the transit of water vapour across the membrane.

Preferably, the sweep gas is heated, e.g. to a temperature greater than the ambient temperature, before entering the membrane. The sweep gas may be heated using the same source of heat as mentioned above for heating the liquid to be treated. It is considered counter-intuitive to heat the sweep gas, because usually the sweep gas would be cooled in order to promote the partial pressure gradient for water vapour across the membrane. However, in the context of a small scale urine treatment process, heating the sweep gas reduces the relative humidity of the sweep gas, enabling it to entrain more water vapour.

Subsequently, the water vapour may be condensed from the sweep gas exiting the membrane. Conveniently, this may be done in a passive heat exchanger, in which the outlet sweep gas is cooled by ambient air, the ambient air thereby being heated and subsequently being used as replacement sweep gas.

As already mentioned, where the urine is faecally-contaminated urine, the present invention provides a particularly effective approach to treating the liquid in the context of a small scale domestic toilet system.

Preferably, the membrane has a comparatively low throughput. In that sense, the system can be considered to be inefficient compared with other filtration applications. However, for the reasons explained in this disclosure, of greater concern is the ability to treat urine in a cost- and power-effective manner, and the throughput is not the most significant factor in that assessment. Preferably, the throughput of the membrane is up to 150 L per day.

Similarly, the flux efficiency of the membrane may be comparatively low, for corresponding reasons. Preferably, the flux efficiency of the membrane when used in accordance with preferred embodiments of the invention is up to 10 L m⁻² h⁻¹. More preferably the flux efficiency of the membrane is up to 8 L m⁻² h⁻¹.

Further optional features of the invention are set out below.

### BRIEF DESCRIPTION OF THE DRAWINGS

Embodiments of the invention will now be described by way of example with reference to the accompanying drawings in which:

FIG. 1 shows a schematic view of a toilet system according to an embodiment of the invention.

FIG. 2A shows a schematic explanation of the conditions used for known sweeping gas membrane distillation.

FIG. 2B shows a schematic explanation of the conditions used for the sweeping gas membrane distillation type of process used in preferred embodiments of the invention.

FIG. 3 shows a schematic arrangement combined with a flow chart corresponding to the process of FIG. 2A, illustrating the liquid and gas inlets and outlets, and their associated heat exchangers.

FIG. 4 shows a schematic arrangement combined with a flow chart corresponding to the process of FIG. 2B, which is a process according to an embodiment of the invention, illustrating the liquid and gas inlets and outlets, and their associated heat exchangers.

FIG. 5 shows an SEM micrograph of a cross section of a hollow fibre membrane.

FIG. 6 shows an SEM micrograph of a cross section of another hollow fibre membrane.

FIG. 7 shows an SEM micrograph of a cross section of another hollow fibre membrane.

FIG. 8 shows a graph of the flow across hollow fibre membranes of different internal diameter under isothermal conditions against an indication of cost.

FIG. 9 shows the permeate flux profile during the membrane distillation of real urine over a 60 hour period.

FIG. 10 shows the permeate flux profile during the membrane distillation of synthetic urine over a 60 h period, indicating that the influence of urine constituents on the permeate flux decline with time.

FIG. 11 shows a view of the liquid side surface of a hollow fibre membrane after use in an embodiment of the invention for 72 hours, taken using a microscopic technique which allows for non-invasive real-time analysis of fouling at the membrane surface during water treatment. This image shown in FIG. 11 shows development of a fouling layer formed at the membrane surface which does not significantly constrain water permeation.

FIG. 12 shows the gas outlet relative humidity relative to the sweep gas speed (v_{g}), and the variation of this behaviour based on the internal diameter of the hollow fibre membrane.

FIG. 13 shows the enhancement in mass transfer rate of water vapour as a function of sweep gas flow rate.

FIG. 14 shows the normalised permeate flux (J/J₀) for an initial filtration operation for more than 20 hours, compared with a subsequent filtration operation after physical cleaning of the membrane module and compared with a subsequent filtration operation after chemical cleaning of the membrane module.

FIG. 15 shows the development of crystallised salts which can be removed either in-situ with occasional mild shearing or can be acid eluted during membrane maintenance cycle. The recovered crystalline product is formed of N,P and K in an equivalent stoichiometric ratio to some fertilisers.

### DETAILED DESCRIPTION OF THE PREFERRED EMBODIMENTS, AND FURTHER OPTIONAL FEATURES OF THE INVENTION

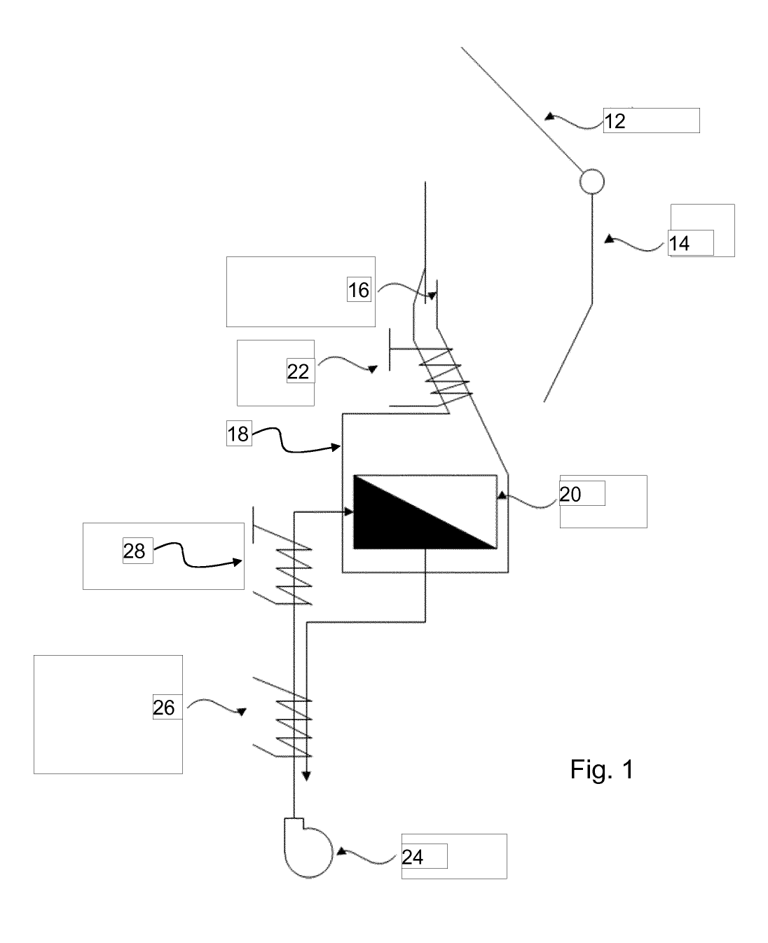

FIG. 1 shows a schematic view of a toilet system according to an embodiment of the invention. It is intended that the toilet system is freestanding and has a compact design. It is intended to be used without the need for an external power supply, or an external source of water.

The toilet system has a lid 12 and a seat, in the manner that a user would normally expect. Faeces and urine are received in the bowl 14 of the toilet. Subsequently, the faeces and urine are emptied from the bowl into a waste collection region. The faeces and urine are separated into a faecal sludge fraction and faecally-contaminated urine, under the influence of gravity. The faecally-contaminated urine is diverted (via a weir 16 or a physical separator, for example) into a reservoir 18. In some parts of this disclosure, the faecally-contaminated urine will be referred to as urine or liquid to be treated.

The separation membrane 20 is provided in the form of a bundle of hollow fibres. These extend substantially parallel to each other and are potted at each end into respective inlet and outlet manifolds (not shown) in a manner well understood to the skilled person. The liquid side of the separation membrane is the external surface of each hollow fibre. The liquid is able to permeate in gaps between adjacent fibres. The gas side of the separation membrane is the internal surface of each hollow fibre. The inlet manifold is connected to the sweeping gas inlet, for sweep gas to be transmitted along the lumens (the interior spaces of) the hollow fibres.

The liquid to be treated is optionally heated using waste heat available from the toilet system. For example, heat may be generated by combustion of faeces, e.g. in a gasifier. The liquid to be treated is heated at liquid side heat exchanger 22.

The liquid to be treated is brought into contact with the liquid side of the separation membrane. This may be by flow under the influence of gravity alone. It is not considered to be necessary to pump the liquid to be treated, or to pressurise it. This is particularly beneficial, because it reduces the need for an external energy input into the toilet system.

At the gas side of the separation membrane, a sweep gas (in this case, air) is moved along the interior of the hollow fibres. The flow of the sweep gas is generated by gas flow means 24. The flow of the sweep gas may be generated by a blower. However, typically a blower uses energy in order to take into account the adiabiatic expansion coefficient of the gas as it pressurises to overcome a head pressure. It is possible to use a blower, particular when operated at low power, but it is also possible to use a lower cost component such as a fan. A suitable fan is a squirrel fan, for example. The power required for operation of the blower or fan is low because the velocity of the sweep gas can be low and yet still the treatment system provides satisfactory treatment of urine.

The sweep gas is preferably heated. This reduces its relative humidity, which is beneficial for the driving force for water vapour passing through the membrane. The sweep gas may be heated using the same heat source as used to heat the liquid to be treated. As shown in FIG. 1, the sweep gas is heated by a primary air-side heat exchanger 26 and by a further air-side heat exchanger 28. The operation of these heat exchangers is explained in more detail below.

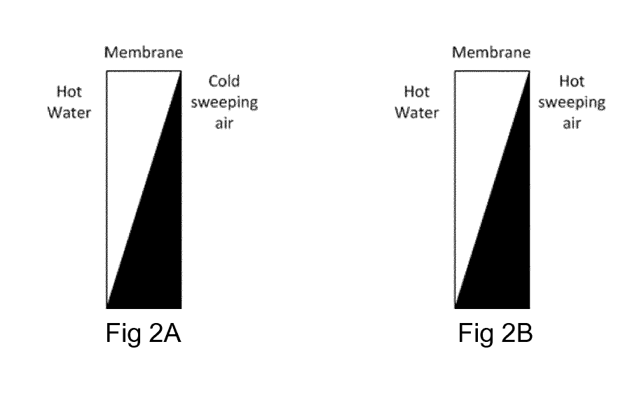

In known sweep gas membrane distillation processes, the liquid (typically water-based) is heated, in order to promote vapourisation of the water. This is illustrated in FIG. 2A. In contrast, in the present invention, preferably the sweep gas is heated. This is illustrated in FIG. 2B. This is explained in more detail below.

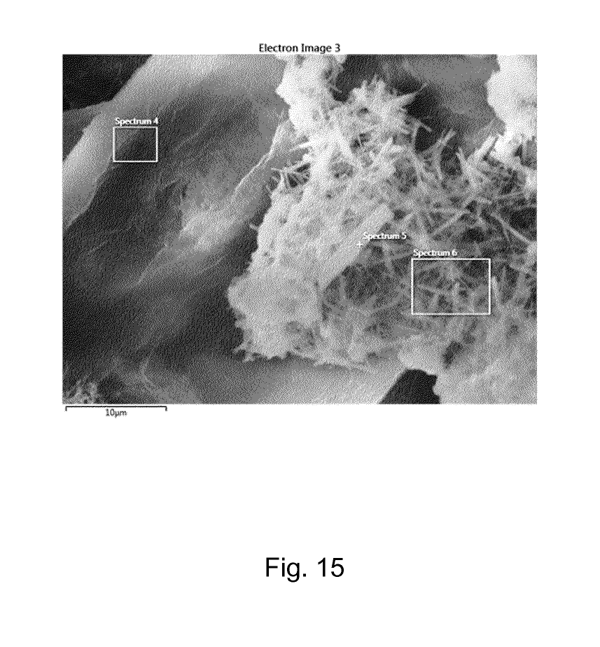

Known membrane distillation processes, such as those used either for industrial separations or for desalination, use high liquid recirculation velocities. This is typically preferred in order to limit ‘concentration polarisation’ effects, because this drives enhancement to mass transfer. However, in the preferred embodiments of the present invention, low or no recirculation in the liquid is preferred. There are several reasons for this. One reason is that this is a small scale application and so is less sensitive to driving down capital cost (i.e. reducing membrane surface area through enhancing mass transfer). A second reason is that one priority of this small scale (e.g. single household) toilet system is to minimise energy inclusion and so minimal liquid pumping is preferable. A third reason is that there may be advantage in generating ‘concentration polarisation’ in the context of urine treatment. This is because concentration polarisation can stimulate growth of inorganic precipitates (such as struvite and ammonium bicarbonate, shown in FIG. 15) which can be recovered from the separation membrane to be used as fertiliser for local redistribution in agricultural applications.

Rather than pumping the liquid, the separation membrane is instead immersed within the tank containing the urine. The membranes are preferred in hollow fibre geometry, although other geometries are possible, since this provides more specific surface area and will limit operational pressure drop on the gas-side of the membrane which is again preferable in order to limit the overall energy budget.

The bundle of fibres are held loosely relative to each other, in order to reduce or avoid clogging of the fibres in the bundle. This is a different configuration to other hollow-fibre membrane distillation studies known to the inventors, where the fibres are ordinarily packed very tightly and containerised within a ‘shell’ (a tube) which allows for high velocities through the bundle. In the preferred embodiments of the present invention, the bundle is kept open. There is considered to be a trade-off between (i) the bundle being sufficiently loose to not lose surface area quickly at the initiation of filtration due to clogging, versus (ii) not making the overall module dimension too large because of the increase in interstitial fibre spacing. It is possible to maintain the toilet system by employing a modular approach to the membrane bundle. The membrane bundle may be incorporated as a module which can be easily removed from the system, and immediately replaced with a fresh module, so that the system con continue operation. The ‘dirty’ module may then be regenerated, e.g. physically or chemically. A suitable physical cleaning process is gas scouring, for example. This serves to loosen and concentrate the residual deposit. The regeneration of the module may be carried out on site or off site.

The membrane material used can be microporous (generally hydrophobic in nature), for membrane distillation processes, or of a dense wall construction, for pervaporation processes. Either type of membrane material enable substantial reductions in bacterial contamination, solids and saline concentration and so provide a clean permeate. The use of a dense membrane material can also foster a reduction in volatile organic compounds (so-called VOCs) which can be present in dissolved form within the water causing odour (and perhaps taste) issues by providing an additional selective transport for water over VOCs through solution-diffusion mechanisms. Such constraints are not considered in known membrane distillation applications.

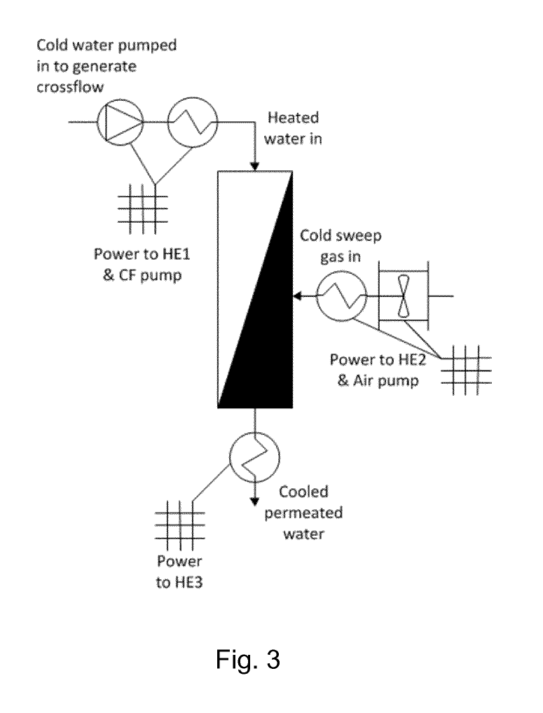

In the schematic arrangement of FIG. 3, the contaminated water source (typically sea water) is contacted on one side of a membrane, whilst a cold gas is passed on the opposing side of the membrane. In FIG. 3, the sea water is pumped to generate a crossflow. The sea water is heated via a heat exchanger (HE). Both the pump and the heat exchanger require power. The heated water is flowed into the membrane module, on the liquid side. On the gas side, cold sweep gas is blown. The sweep gas is cooled using a separate heat exchanger. The blower and the heat exchanger each require a power input. The temperature gradient across the membrane provides a vapour pressure gradient to drive mass transfer. The humidified sweep gas is conveyed out of the membrane module and the water vapour carried by it is condensed out at a further heat exchanger, which requires a further power input.

For applications such as industrial-scale or utility-scale applications, capital cost (membrane cost) is of significant importance and as such optimising membrane flux and water recovery are prioritised. This means optimising the thermal gradients where possible. In the example arrangement shown in FIG. 3, power is used (i) to heat the contaminated fluid; (ii) to cool the incoming sweep gas prior to entry into the membrane which will then conduct heat during passage through the membrane; (iii) to cool the permeate to ensure recovery of water vapour into a liquid state; (iv) for pumping contaminated water through the retentate channel to ensure a sufficient velocity is maintained to maximised mass transfer through the membrane (and so reduce capital cost); and (v) for pumping of the sweep gas, or alternatively provision of a vacuum where vacuum membrane distillation is considered.

In the preferred embodiments of the present invention, whilst capital cost remains important in application to the toilet system, operating cost is in fact of greater importance as there is little available power. There may, however, be plentiful available heat. Furthermore, the treatment priority is to reduce contaminated water volume rather than to produce a water product specifically and so maximising either flux or water recovery are not priorities but rather are added value.

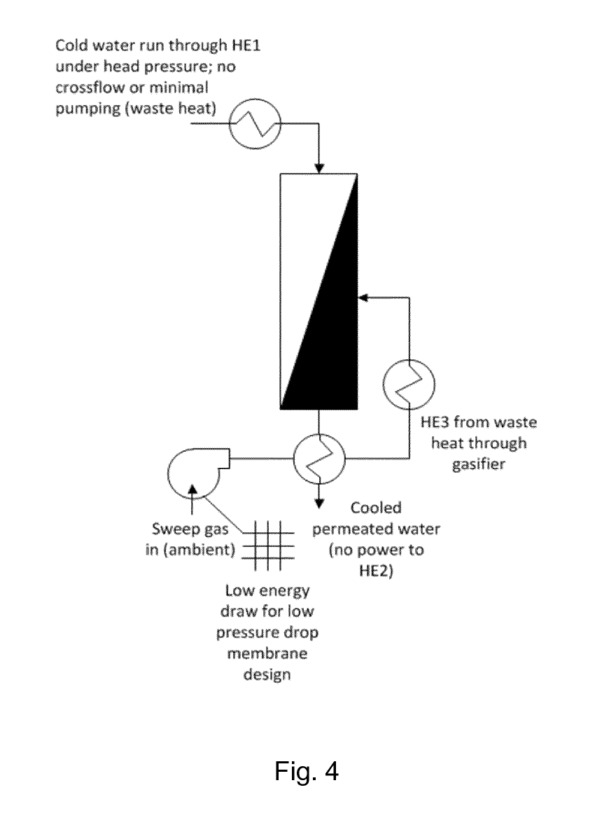

In the schematic arrangement of FIG. 4, representing an embodiment of the invention, the liquid to be treated is fed under gravity to the membrane module. The liquid may be heated, using waste heat available to the toilet system. Typically there is no crossflow, or minimum pumping of the liquid to be treated. The liquid to be treated makes contact with the liquid side of the membrane, as discussed above. A fan (or blower) is provided, drawing lower power, because the required air flow rate is very low. The sweep gas is heated at a heat exchanger using waste heat available to the toilet system. The sweep gas is conducted along the lumens of the hollow fibres, entraining water vapour as described above. The humidified outlet sweep gas is passed through a heat exchanger with the inlet sweep gas, in order to heat the inlet sweep gas and to condense water out of the outlet sweep gas. No net power needs to be supplied to this heat exchanger. A further heat exchanger may be used to heat the inlet sweep gas further, for example using waste heat available to the toilet system. Suitable waste heat may be provided, for example, by combustion of the faeces received by the toilet, for example in a gasifier.

As such the preferred embodiments of the invention promote several benefits:
Heating of the liquid to be treated can be undertaken using waste heat and in doing so requires no specific power requirement.
The liquid to be treated is introduced through a heat exchanger using either no or minimal pumping duty. Furthermore, it is proposed not to try to control ‘concentration polarisation’ (such control would usually be provided by pumping the liquid to be treated) but instead to promote ‘concentration polarisation’. Therefore, the requirement for liquid phase pumping is negligible to nil.
By using hollow fibre membranes, it is possible to select a hollow fibre internal diameter that reduces gas side pressure drop. In turn, this permits the use of very low pressure air fans rather than pump. This reduces both capital and operating costs.
Furthermore, as the saturation vapour pressure of water in the gas phase is an exponent of rising temperature, heating the gas phase increases the water vapour carrying capacity and reduces the gas flow rate needed which in turn reduces gas-side pressure drop.
The further benefit of choosing a high temperature gas phase rather than a cold temperature gas phase is that the outlet sweep gas can be input into a passive heat exchanger with ambient air on the opposing side. This then condenses and recover clean water passively without requiring any input power.
The heat recovered by the ambient air that is included on the opposing side of the heat exchanger is then the incoming air to make up the fresh sweep gas. Increasing the temperature reduces the relative humidity which means greater fluid carrying capacity but also means that much of the heat used for water transport within the system is recovered and as such minimises the total energy budget.

The inventors have carried out a study of suitable hollow fibre internal diameters for the membrane.

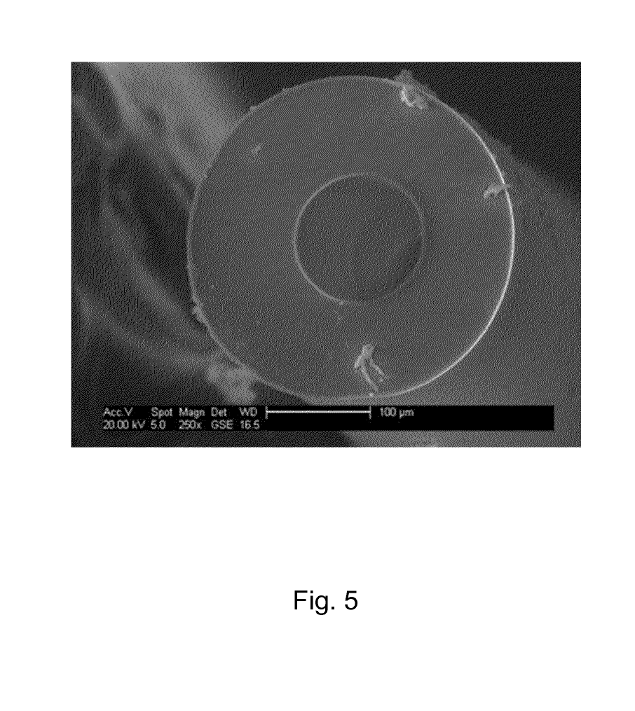

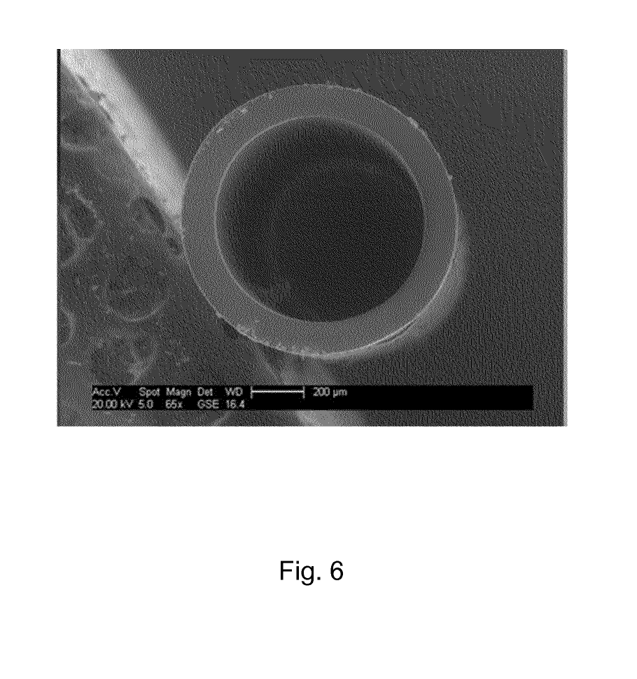

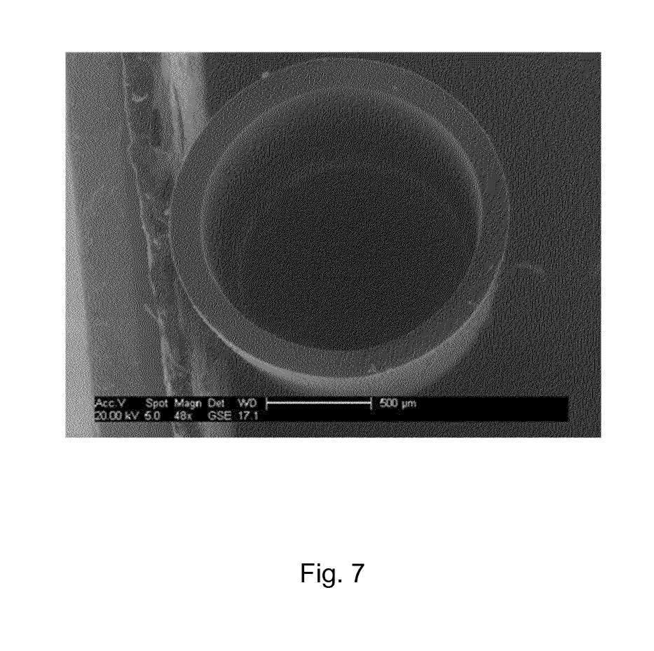

FIGS. 5-7 show SEM micrographs of cross sections of hollow fibre membranes. Note the difference in scale bar—each hollow fibre membrane has a wall thickness of about 100 μm.

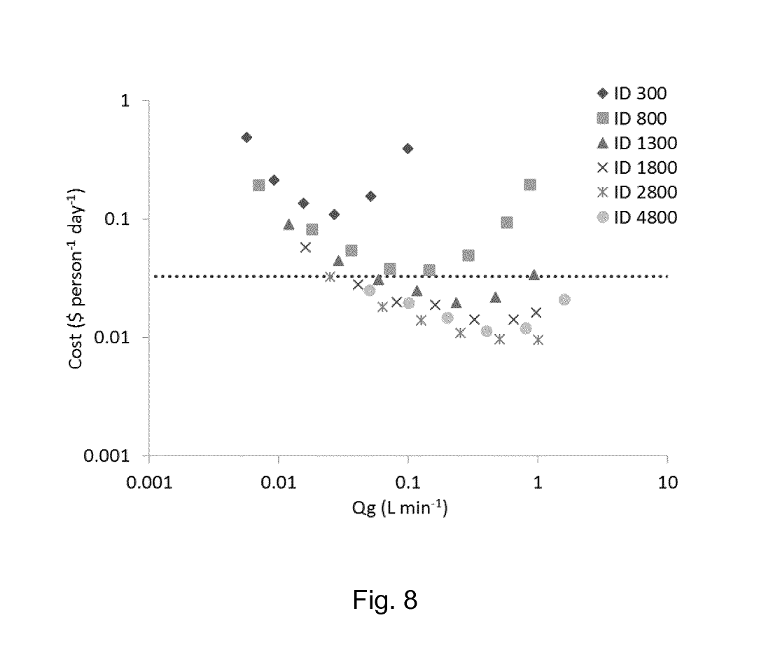

An assessment was carried out to consider the internal hollow fibre diameters suitable for providing membrane capability to transport water cost effectively. The testing was undertaken at isothermal conditions (i.e. equivalent temperatures) and at low driving temperatures. These are not ideal conditions, but serve to illustrate the principle of the determining cost effectiveness. The analysis was based on the production of 15 L of water per day (equivalent to a 10 person toilet) and includes the capital cost of the membrane and the power cost priced at a standard electrical energy tariff (FIG. 8). The costs are compared to the tariff of $0.05 per person per day which has been outlined as an economically achievable target for the provision of sanitation to the urban poor. What is clear from FIG. 8 is that even without enhancement of temperature, the proposed membrane configuration is able to achieve the sanitation target. The values for internal diameter (ID) are given in units of μm.

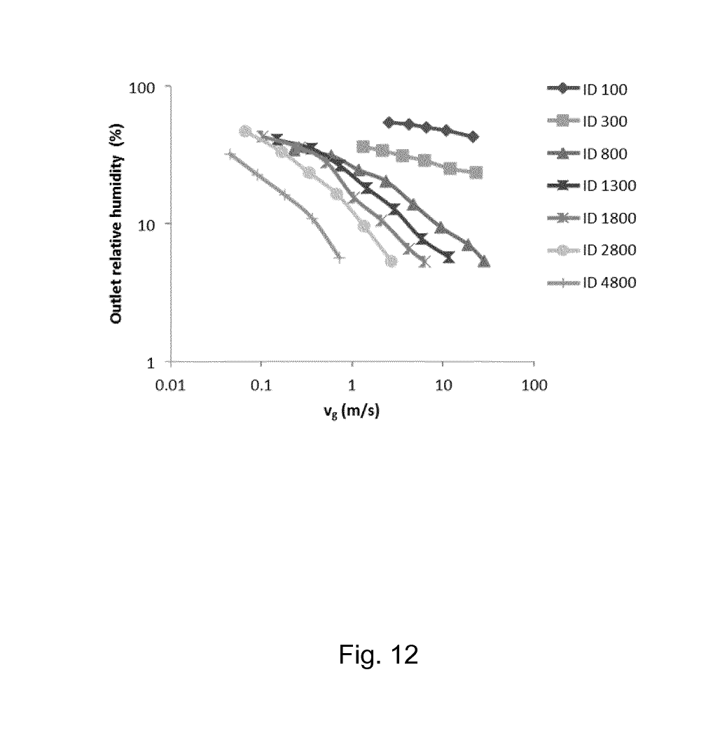

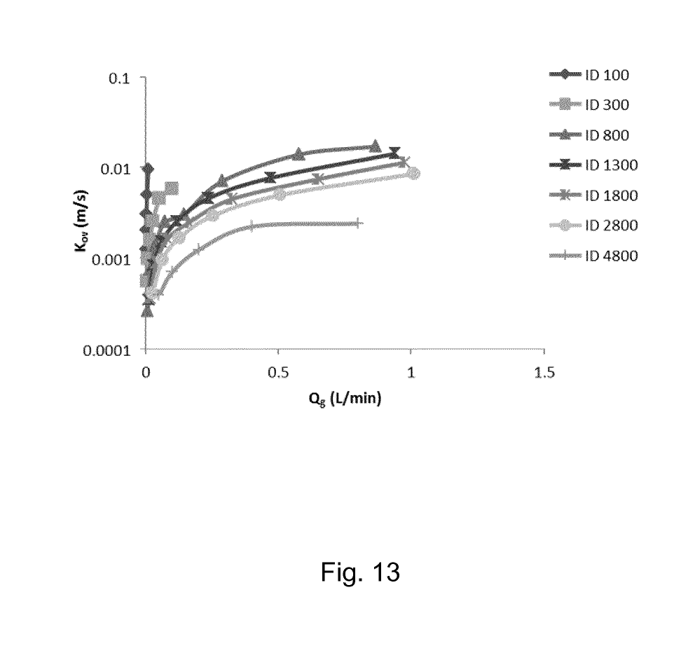

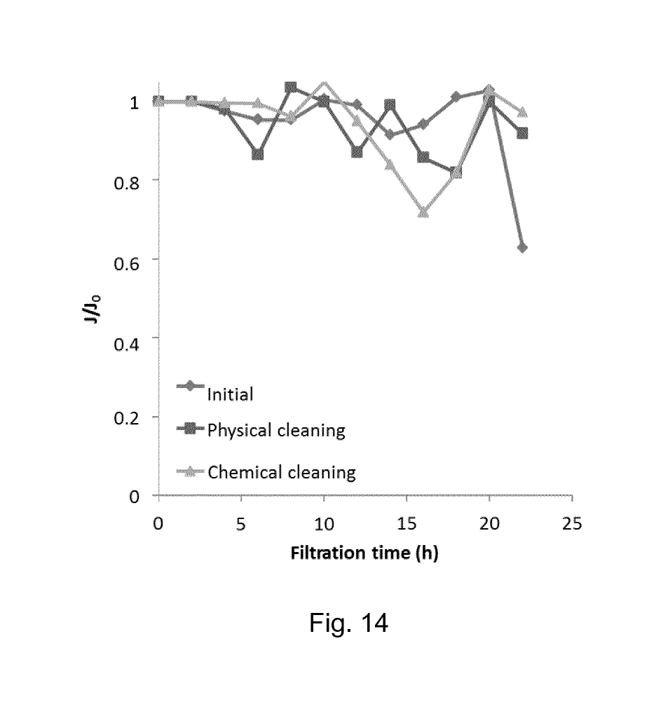

FIG. 12 demonstrates that for fibres with lower lumen diameter, better humidification of the gas phase can be achieved. This is because of the increased mass transfer (k, m/s) provided by the shorter characteristic length (diameter, μm) (see FIG. 13).

According to the knowledge of the inventors, there is no available work in the prior art which discloses the approach of sweeping gas membrane distillation (or pervaporation) applied of the treatment of urine or faecally contaminated urine. Still further, there is no guidance in the art which would suggest operating the liquid-side conditions preferably in the ‘concentration-polarisation’ state, because this would be counter-intuitive relative to the literature. However, as the preferred embodiments of the invention are used on a small scale (i.e. in a domestic environment, seeking to treat only less than 150 L of liquid per day, for example, the capital cost of the membrane is likely to be low. Of greater interest is the operating cost. Therefore it is preferred to operate the membrane with minimal or no fluid pumping on the liquid side. This limits the need for electrical power by avoiding liquid side pumping. This means accepting a degree of membrane fouling and managing the gradual loss of ‘flux’ through increasing specific surface area (i.e. providing a greater available area of membrane). This can be done because the liquid volume throughput is small and so is the relative capital cost. There is in fact a preference towards a ‘concentration polarisation’ state, because this promotes crystallisation at the membrane surface. This enables the retention and recovery of nutrient rich salts in solid form which can be collected and used as fertiliser.

A suitable microporous hydrophobic hollow fibre membrane (PTFE) was tested in real and synthetic urine. In this test, vacuum was used instead of sweep gas as the driving force simply due to the scale of the experimental facility. Vacuum here is used simply as a driving force and so the identified results provide direct translation to the boundary conditions of the treatment process using a sweep gas.

In the preferred embodiments of the present invention, the membrane is hydrophobic, providing a barrier for the contaminated liquid phase and enabling only water vapour to pass through the pores. A condensation stage is then required to transform water vapour into pure liquid water.

Bench scale lab based experiments have demonstrated the potential of this technique for the treatment of urine to produce high purity water that can potentially be used for irrigation, washing or even cooking and drinking purposes. Over 97% of all urine constituents were retained by the membrane after 60 h of operation (see Table 2) with all the urea being retained (99.98% after 60 h), more than 99% of the salts and over 97% and 98% of ammonium and organics respectively. This represents in term of absolute concentrations in the permeate: 3 mg·L⁻¹ of urea, 4 mg·L⁻¹ of ammonium, 40 mg·L⁻¹ of COD and a conductivity of 100 μS·cm⁻¹. In addition to the quality of the water produced, another critical parameter is the permeate flux generated (volume of water produced per surface area of membrane and per unit time, usually L·m⁻²·h⁻¹) and more precisely the variation of permeate flux over time.

The energy demand in membrane filtration is constrained by the high particle concentrations which can lead to the formation of concentrated fouling layers at the membrane surface and therefore impedes the passage of water through the membrane, requiring the membrane to be cleaned (physically or chemically) to recover the performances.

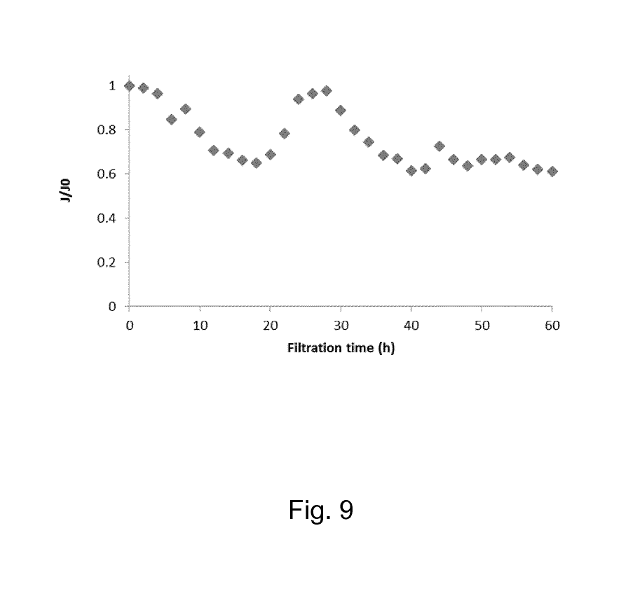

FIG. 9 shows the permeate flux profile during the membrane distillation of real urine over a 60 h period. The initial permeate flux was 2.05 L·m⁻²·h⁻¹, the feed temperature was 60° C., the condenser temperature was 2° C., the vacuum pressure was 40 mBar, the cross flow velocity was 11 mm·s⁻¹. The membrane is formed from PTFE hollow fibres with inner diameter 1.51 mm, wall thickness 200 μm, sourced from Markel Corporation (Plymouth Meeting, Pennsylvania, USA).

As can be seen in FIG. 9, 60% of the initial flux was still passing through the membrane after 60 h of operation, with the flux passing from an initial 2.05 L·m⁻²·h⁻¹ to 1.25 L·m⁻²·h⁻¹.

Consideration of the constituents of urine and the influence of these constituents on membrane performances was taken using an analog of typical human urine published by NASA (1972) (Table 1).

TABLE 1
Analog representing the composition of typical human
urine. Adapted from NASA (1972) - In bold, the chemicals
used to produce the synthetic urine.

| Item | Amount (mg · L⁻¹) |
|---|---|
| Inorganic salts | 14,157 |
| Sodium chloride | 8,001 |
| Potassium chloride | 1,641 |
| Potassium sulfate | 2,632 |
| Magnesium sulfate | 783 |
| Magnesium carbonate | 143 |
| Potassium bicarbonate | 661 |
| Potassium phosphate | 234 |
| Calcium phosphate | 62 |
| Urea | 13,400 |
| Organic compounds | 5,369 |
| Creatinine | 1,504 |
| Uropepsin (as Tyrosine) | 381 |
| Creatine | 373 |
| Glycine | 315 |
| Phenol | 292 |
| Histidine | 233 |
| Androsterone | 174 |
| 1-Methylhistidine | 173 |
| Imidazole | 143 |
| Glucose | 156 |
| Taurine | 138 |
| Cystine | 96 |
| Citrulline | 88 |
| Aminoisobutyric acid | 84 |
| Threonine | 83 |
| Lysine | 73 |
| Incloxysulfuric acid | 77 |
| m-Hydroxihippuric acid | 70 |
| p-Hydroxyphenyl - | 70 |
| hydrocrylic acid | |
| Inositol | 70 |
| Urobilin | 63 |
| Tyrosine | 54 |
| Asparagine | 53 |
| Organics less than 50 mg/L | 606 |
| Organic ammonium salts | 4,131 |
| Ammonium: | |
| Hippurate | 1,250 |
| Citrate | 756 |
| Glucuronate | 663 |
| Urate | 518 |
| Lactate | 394 |
| L-Glutamate | 246 |
| Asparate | 135 |
| Formate | 88 |
| Pyruvate | 44 |
| Oxalate | 37 |

Experiments were undertaken to evaluate the impact of inorganic salts, organic compounds, ammonium salts and urea on permeate quality and permeate flux. This set of experiments demonstrated the clear impact of ammonium salts on the reduction of permeate flux.

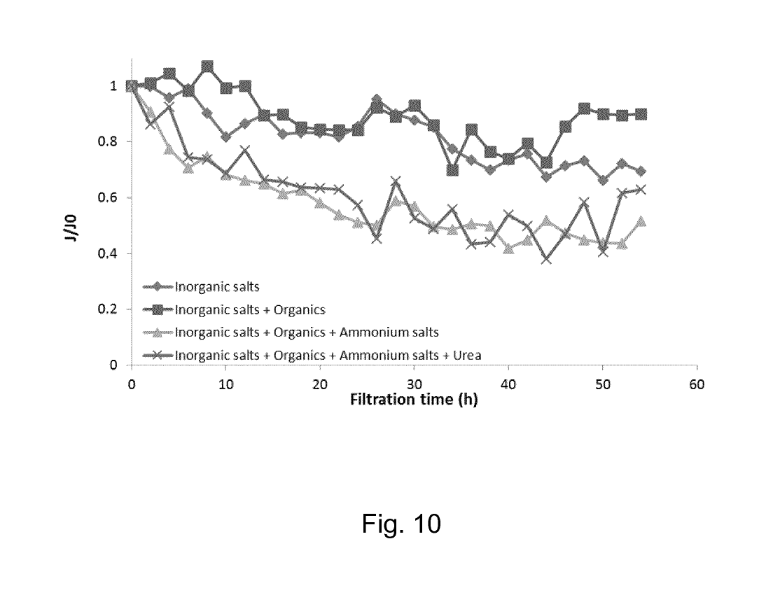

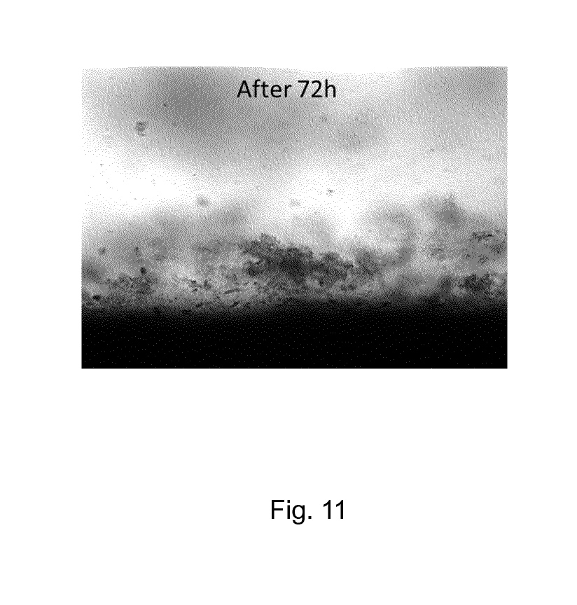

FIG. 10 shows the permeate flux profile during the membrane distillation of synthetic urine over a 60 h period, indicating the influence of urine constituents on permeate flux decline. The initial permeate flux was 2.5-3.6 L·m⁻²·h⁻¹, the feed temperature was 60° C., the condenser temperature was 2° C., the vacuum pressure was 40 mBar, the cross flow velocity was 11 mm·s⁻¹.

While more than 80% of the initial flux was recovered after more than 50 h of filtration in the absence of ammonium salts (inorganic salts and inorganic salts plus organic compounds), the flux declined to 60% of initial flux after 15 h in the presence of ammonium salts. The quality of the filtered water was very high in all the conditions (over 97% rejection in all cases after 60 h of filtration—see Table 2), demonstrating that a decrease in flux performances did not result in pore wetting.

TABLE 2
Summary of membrane performances in term of water quality.
The table expresses the percentage of organics, urea, salts and
ammonium retained by the membrane over 60 h of filtration.

Rejection (%)

| Time (h) | COD | Urea | Salts | Ammonium |
|---|---|---|---|---|
| 4 | 98.44 | 99.97 | 99.49 | 98.19 |
| 23 | 98.47 | 99.97 | 99.24 | 98.07 |
| 27 | 98.32 | 99.97 | 99.29 | 97.78 |
| 45 | 98.55 | 99.97 | 99.28 | 97.54 |
| 50 | 98.39 | 99.97 | 99.21 | 97.33 |
| 60 | 98.35 | 99.97 | 99.19 | 97.17 |

As will be appreciated, various membrane materials may be used in preferred embodiments of the invention. For example, zeolite membrane may be used. Alternatively, PP (polypropylene), PTFE, PVA and/or PDMS materials may be used.

Preferably, the liquid side temperature is in the range 50-60° C. The liquid at the liquid side may be substantially stagnant.

The membrane may be cleaned in order to prolong its useful life. Table 3 illustrates the results of treatment of urine after different types of cleaning process. Table 3 demonstrates the recovery of organics from the membrane surface in the cleaning rinse fluids following physical or chemical cleaning

TABLE 3
Effect of different cleaning processes

| | | Deposit COD |
|---|---|---|
| Type | Solvent | (g m⁻²) |
| Initial run | — | — |
| Physical clean | DI water | 18.4 |
| Chemical/physical clean | DI water | 12.6 |
| | Citric acid | 4.5 |
| | NaOH | 3.4 |
| | DI water | 3.6 |

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

All references referred to above are hereby incorporated by reference.

1. A process for treating urine, the process including the steps:
containing urine in a reservoir;
providing a separation membrane having a liquid side and a gas side;
contacting the urine in the reservoir with the liquid side of the separation membrane;
generating a sweep gas flow on the gas side of the separation membrane;
conducting water in the urine from the liquid side to the gas flow side of the separation membrane, the separation membrane substantially preventing the passage of other components of urine from the liquid side to the gas flow side of the separation membrane, the water conducted to the gas flow side of the separation membrane being entrained in the sweep gas flow.

2. A process according to claim 1 wherein the membrane is in the form of hollow fibre.

3. A process according to claim 2 wherein the interior of the hollow fibre provides the gas side of the membrane and the exterior of the hollow fibre provides the liquid side of the membrane.

4. A process according to claim 2 wherein the inner diameter of the hollow fibre is in the range 100-5000 μm.

5. A process according to claim 1 wherein the membrane has a wall thickness in the range 10-500 μm.

6. A process according to claim 1 wherein the sweep gas in the gas side of the membrane is at a pressure not less than, or not substantially less than, atmospheric pressure.

7. A process according to claim 1 wherein the sweep gas in the gas side of the membrane is at a pressure not substantially greater than atmospheric pressure.

8. A process according to claim 1 wherein the liquid to be treated is heated to a temperature greater than the ambient temperature.

9. A process according to claim 1 wherein the sweep gas is heated to a temperature greater than the ambient temperature before entering the membrane. (Original) A process according to claim 9 wherein the sweep gas is air heated in a heat exchanger at least in part by gas exiting from the membrane, thereby cooling the gas existing from the membrane and promoting condensation of water vapour entrained in the gas existing from the membrane.

11. A process according to claim 8 wherein the heating is provided by waste heat.

12. A urine-treatment apparatus having:
a reservoir for containing urine to be treated;
a separation membrane having a liquid side and a gas side, the separation membrane being capable of conducting water in the urine to the gas flow side and capable of substantially preventing the passage of other components of urine to the gas flow side; and
air flow means for generating a sweep gas flow on the gas side of the separation membrane,
wherein the apparatus is operable to extract water from the urine into the sweep gas flow.

13. A toilet system, the toilet system being adapted to receive human waste including urine and optionally faeces, the toilet system having a urine-treatment apparatus having:
a reservoir for containing urine to be treated;
a separation membrane having a liquid side and a gas side, the separation membrane being capable of conducting water in the urine to the gas flow side and capable of substantially preventing the passage of other components of urine to the gas flow side; and
air flow means for generating a sweep gas flow on the gas side of the separation membrane,
wherein the apparatus is operable to extract water from the urine into the sweep gas flow, the toilet system further having a waste collection region from which urine is conducted to the reservoir of the urine-treatment apparatus.
